(19) United States
(12) Patent Application Publication
(10) Pub. No.: US 2002/0140940 A1
(43) Pub. Date: Oct. 3, 2002

(54) System and method for measurement and analysis of a sample by absorption spectrophotometry

(76) Inventors: Shabbir B. Bambot, Suwanee, GA (US); Scott Kerr, Stone Mountain, GA (US); Mark A. Samuels, Norcross, GA (US); Henry Grage, Alpharetta, GA (US); Gregory J. Newman, Fremont, CA (US)

Correspondence Address: Fleshner & Kim, LLP, P. O. Box 221200, Chantilly, VA, 20153-1200, US

(21) Appl. No.: 10/084,273

(22) Filed: Feb. 27, 2002

Related U.S. Application Data
(60) Provisional application No. 60/272,112, filed on Feb. 28, 2001.

(51) Int. Cl. G01N 21/47

(52) U.S. Cl. 356/446

(57) ABSTRACT

A system and method for measurement and analysis of a sample by absorption spectrophotometry is taught by the present invention. According to various embodiments, the invention utilizes a novel receptacle comprising of at plurality of layers including a transparent layer, a channel layer, and a reflective layer coupled to one another and allowing for fluid communication within and among the layers to allow for illumination by a light source and interrogation and analysis by a light measuring device. Examples of the light source and light measuring devices that could be used with the present invention include reflectance and/or fluorescence spectroscopy and a spectrometer, respectively. Measurement and analysis of a sample is compared to known values of constituents for comparison.

### CROSS REFERENCE OF RELATED APPLICATIONS

This application claims priority to U.S. provisional application 60/272,112 filed on Feb. 28, 2001, the entirety of which is incorporated herein by reference.

### BRIEF DESCRIPTION OF THE DRAWINGS

FIG. 1 shows a schematic diagram of an aspect of the method of the invention according to an embodiment.

FIGS. 2A and 2B show top/bottom view and a staggered side view, respectively, of an aspect of a device of the invention according to an embodiment of the invention.

FIG. 3 is an illustrative graph of absorbance wavelengths of characteristics of a blood sample.

FIG. 4 shows the components of one aspect of the invention according to another embodiment.

FIG. 5A shows a side view of an aspect of the invention according to an embodiment; FIG. 5B shows a top view of the aspect of the invention shown in FIG. 5A.

FIG. 6 shows another aspect of the invention according to an embodiment.

FIG. 7 shows another embodiment of the invention.

### SUMMARY OF THE INVENTION

A system and method for measurement and analysis of a sample by absorption spectrophotometry is taught by the present invention. According to various embodiments, the invention utilizes a novel receptacle comprising of at plurality of layers including a transparent layer, a channel layer, and a reflective layer coupled to one another and allowing for fluid communication within and among the layers to allow for illumination by a light source and interrogation and analysis by a light measuring device. Examples of the light source and light measuring devices that could be used with the present invention include reflectance and/or fluorescence spectroscopy and a spectrometer, respectively. Measurement and analysis of a sample is compared to known values of constituents for comparison.

### DETAILED DESCRIPTION OF THE INVENTION

The present invention may be understood more readily by reference to the following detailed description of the various embodiments of the invention and the Figures.

Before the present articles and methods are disclosed and described, it is to be understood that the terminology used herein is for the purpose of describing particular embodiments only and is not intended to be limiting. It must be noted that, as used in the specification and the appended claims, the singular forms “a”, “an” and “the” include plural referents unless the context clearly dictates otherwise.

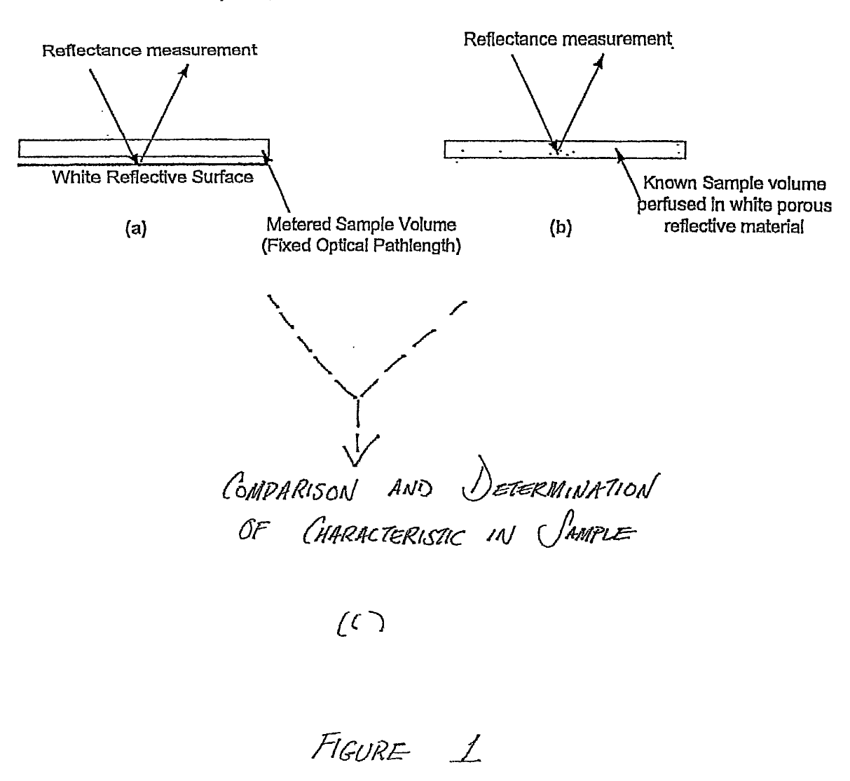

According to its various embodiments, the present invention comprises of a method and a device for measuring a characteristic of a sample by measuring the sample's reflective and/or fluorescent properties. The method comprises the steps of illuminating a sample, interrogating a sample with a light measuring device, collecting the reflected and/or fluoresced light, measuring the reflected light, and determining the characteristic of a sample by comparing the property or properties of the collected light to those of properties of known characteristics. For example, where the sample is blood and the particular characteristic is an analyte, specifically bilirubin, measurements of light absorption at the absorption peak wavelength of bilirubin can yield quantitative information about the concentration of bilirubin in a sample. FIG. 1 shows a schematic example of this measurement and determination of a characteristic in a sample according to various embodiments of the present invention.

Furthermore, the device of the present invention performs the functions/steps taught by the method of the present invention. The device comprises a light source, a light measuring device, and a sample receptacle. The receptacle 100 comprises a reflective surface adjacent to a housing/chamber to store the sample of interest to be measured as the light source interrogates the sample at a first wavelength(s) either directly or through a transparent cover depending on the embodiment. As the light causes the sample to reflect and/or fluoresce at a second wavelength(s), the reflected and/or fluoresced light is collected and measured by a light measuring device, e.g. a spectrometer. In embodiments where the absorbance/fluorescence properties are being measured, the reflective surface comprises of a uniform or otherwise known spectral reflectance. Furthermore, the surface has sufficient backscatter, i.e. a high scattering coefficient and/or low scattering anisotropy so that minimal or no light passes through the layer and vice versa. The measuring device then compares the properties of the collected light to properties of known characteristics, such as particular analytes and/or subcomponents thereof. And depending on the embodiment, the device may, but not necessarily, be powered by a portable energy source such as a battery or a fuel cell. Based on this comparison, the present invention is able to measure and determine a characteristic of a sample.

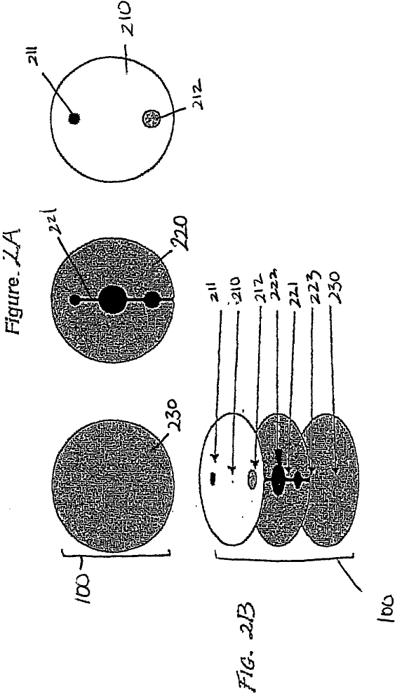

According to an embodiment of the invention, the receptacle 100 may take the shape of a multilayer “sandwich”. As shown by the embodiment in the top view of FIG. 2A and a staggered view as shown in FIG. 2B, the invention comprises of at least three layers. The receptacle 100 may comprise an access layer 210, a channel layer 220, and a base layer 230. The access layer 210 comprises of an opaque reflective surface to serve as the reflective background for the invention. In one embodiment, this reflective access layer is white, however, other colors producing possessing similar reflective or desired reflective properties may be used. Application of various different colors to produce the desired results are common to those skilled in the art. Other colors may be used if the spectrum is known and such that the reflectance may be subject to normalization and produce a “spectrally flat” property.

The layers are coupled in a manner so as operate in a synergistic and cooperative approach. The access layer 210 further comprises of at least a first reflective access opening 211 and at least a second reflective access opening 212. The first reflective access opening 211 allows for the delivery of the sample whereas the second reflective access opening 212 provides a view for visualizing the sample in the layer below. Next, the receptacle 100 comprises of a channel layer 220 coupled to the other layers. The channel layer 220 comprises a channel 221 that may further, but not necessarily, comprise of at least one channel layer opening 222 coupled in fluid and/or gaseous communication with one another such that the liquid traverses via the channel 221 (and thereby the channel layer 220) either by capillary action via a capillary action escape port 223 or some other fluid dynamic means commonly known to those skilled in the art. The channel opening(s) comprise a channel access opening 222 that is in alignment with the first reflective access opening 212 which receives the sample deposited thereinabove and a channel layer view opening 223 that is in alignment with the second reflective access opening 212. The third or base layer 230 serves as the protective layer of the receptacle 100 such that the sample does not escape the channel layer 220 after receipt from the access layer 210. The base layer 230 is transparent to allow for light to penetrate through the receptacle 100 to allow for light interrogation of the sample contained in the channel layer 220 of the receptacle 100. Although it is not shown by the diagrams, it is foreseeable that the aspects and/or qualities of each layer could be combined and merged such that this aspect of the invention comprises of a bilayer or a monolayer.

Using the example above, the present invention utilizes a source of polychromatic light of a known intensity and directs it to a sample deposited in the receptacle 100. In one embodiment [not shown], the light is delivered via a fiber optic probe. As the light passes through the transparent base layer 230 to the sample in the channel layer 220 and hits the reflective access layer 210, a portion of the light reflects, scatters, and/or fluoresces to the source of the light where it is then collected by at least on separate fiber in communication with a spectrometer [not shown].

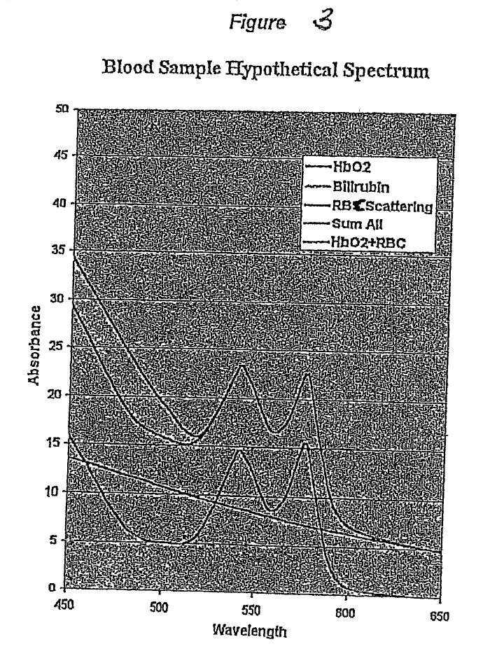

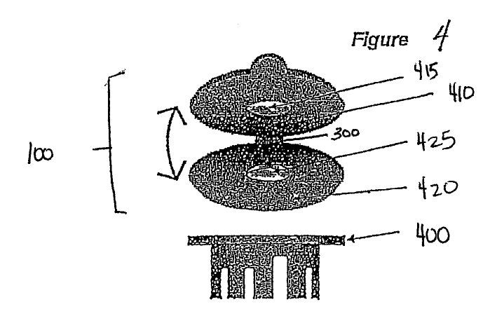

Once the various wavelengths of the light are collected, they are separated and quantified. FIG. 3 shows an illustrative graph where the sample is blood and the characteristics are oxygen-bound hemoglobin, bilirubin, red blood cells, oxygen-bound hemoglobin attached to red blood cells, and a combination of all measured characteristics of the sample. Based on the known light absorption, scattering and/or fluorescent properties of the blood sample constituents, the absorption spectrum is quantified, analyzed and established to identify the contribution made by the characteristics measured within the sample. Once interfering constituents/characteristics are removed, the concentration of a particular characteristic can be determined by, for example, the known molar extinction coefficient of the particular characteristic.

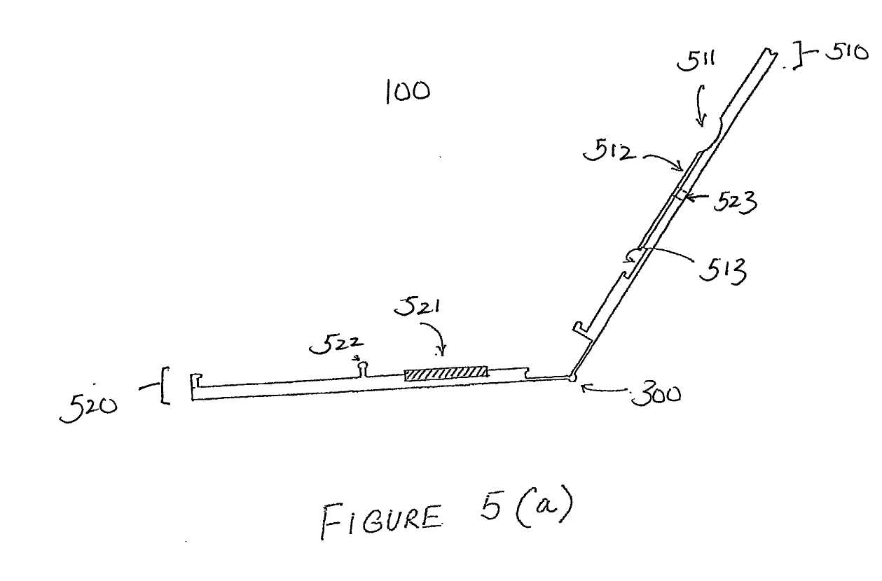

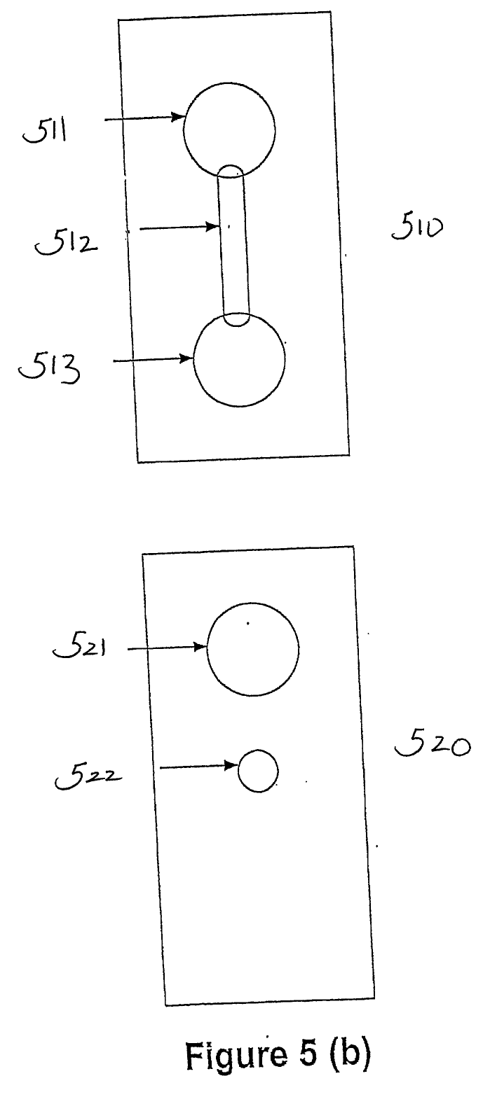

According to another embodiment of the invention as shown in FIG. 4, the receptacle 100 may comprise of a solid inert medium with known light absorption/reflectance/fluorescent properties rather than the “sandwich” approach shown in FIGS. 2A and 2B. The receptacle 100 as shown in FIGS. 4 and 5 show embodiments of the receptacle 100 of the present invention where the receptacle 100 comprises of a first layer 410 capable of being connected or otherwise coupled to a second layer 420. Examples of such connection 300 may include, without limitation, a hinge, adhesives, or mating elements with complementary male and female counterparts. Furthermore, the first 410 and second layer 420 may engage with an attachment 400 of a light interrogating source pathway [not shown] and/or collection pathway [also not shown] as in FIG. 4. In this embodiment, the first layer 410 comprises a reflective section 415 whereas the second layer 420, comprises a second layer chamber 425. The reflective section 415 and the second layer chamber 425 are positioned such that when the first 410 and second layer 420 are brought in contact, they are in alignment and in communication with respect to one another. The chamber 425 contains the inert medium and houses the sample to be analyzed. Furthermore, the chamber comprises of an opening [not shown] or at least a first transparent side [also not shown] and also a second transparent side [also not shown]. In embodiments where the chamber 425 has an opening, the opening allows the reflective surface 415 of the first layer 410 to act as the cover of the chamber 425. In embodiments where the chamber 425 comprises of at least a first transparent side [not shown], the first transparent side can be placed such that it also serves as the cover of the chamber without compromising the reflective characteristics of the first layer 410. The second side of the chamber 425 also provides for the containment of the sample while also providing for a window for a light to pass through to interrogate the sample. Interrogation, collection, measurement, quantification and other analysis utilizing this embodiment is the same as described above with the “sandwich” embodiment.

In embodiments according to FIG. 5A and FIG. 5B, the receptacle 100 comprises of at least two layers connected at at least one end 300. The connection 300 may, for example, comprise of a hinge such that the two layers can attach and separate via this connection. According to this embodiment, the two layers comprise a first layer 510 and a second layer 520. A side view and a top view of each layer is shown in FIG. 5A and FIG. 5B, respectively. As shown in FIG. 5B, the first layer 510 comprises of an application area 511, a capillary channel 512, and a recessed chamber 513 whereas the second layer 520 comprises an indicator membrane 521 and a protrusion 522. Furthermore, the application area 511, channel 512 and the recessed chamber 513 are shaped such that they are recessed areas within the surface of the first layer 510 with the top surface of the application area 511, the capillary channel 512 and sample recessed chamber 513 exposed. With respect to this exposed top surface, a seal is created when the first layer 510 and bottom layer 520 are brought together in proper attachment. Also, the indicator membrane 521 is positioned such that when the first layer 510 and the second layer 520 are brought together in contact with one another, the indicator membrane 521 is aligned with the recessed chamber 513. Similarly, the protrusion 522 is also aligned such that once the first layer 510 and second layer 520 are properly attached, the protrusion 522 enters into a complementary receptor 523 within the channel 512. In further embodiments, there exists a fastener [not shown] to hold the first layer 510 and second layer 520 together in attachment.

According to this embodiment, the sample, e.g. blood, is deposited in the application area 511. The sample then travels via the channel 512 to the chamber 513. When the measurement and analysis is ready to be performed, the first layer 510 and second layer 520 are brought together such that a seal exists between the two layers. The protrusion 522 then engages the receptor 523 thereby interrupting the channel 512 and thereby further interrupting the flow of the sample from the application area 511 into the chamber 513. In further embodiments, the first layer 510 and second layer 520 may be securely attached by a fastener [not shown] or an equivalent thereof to maintain the seal and/or interruption within the channel 512 during measurement and analysis. Once the first layer 510 and second layer 520 are brought together, the indicator membrane 521 is now also properly aligned with the chamber 513. The indicator membrane 521 is analogous to the reflective layer of the previous embodiments of the present invention already disclosed hereinabove. Accordingly, measurement and analysis methods are performed in a similar manner.

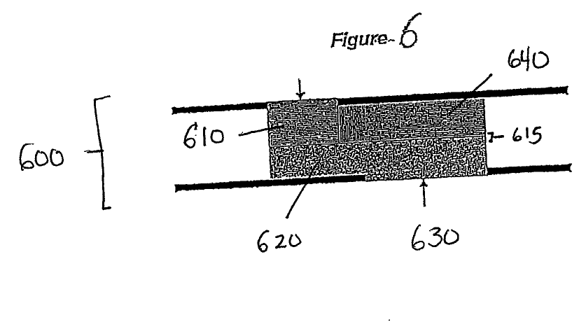

In another embodiment, the sample may be placed on an inert medium 610 such as silica fibers that are in contact with a semipermeable membrane 620 and which is in contact with the sample chamber 600. The chamber 600 may be filled with air or with an inert fluid medium 610 as shown in FIG. 6. When the sample is added to the medium 610, the aqueous portion of the sample along with its constituents/characteristics move across the semipermeable membrane 615 via capillary flow or by osmotic pressure into the measuring and interrogation region 620. Examples of such surfaces include without limitation cellulose, nitrocellulose, PVDF or other similar hydrophilic membranes used for filtration. The characteristics are then filtered and ready to be interrogated, collected, measured, quantified and otherwised analyzed by directing a light source [not shown] and the light collection device [also not shown] at the interrogation aperture 630 upon which light enters and relflects against a reflective aspect 640 and then is collected again through the aperture 630.

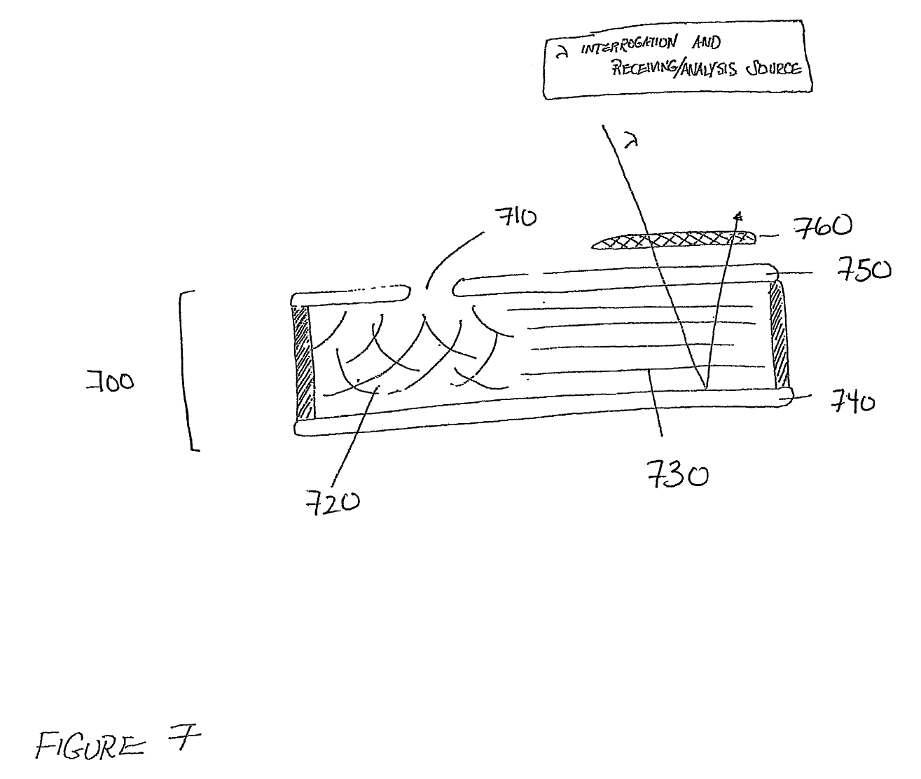

In embodiments as shown according to FIG. 7, the receptacle 100 comprises of an integrated layer 700 for filtering and analysis. According to this embodiment, the integrated layer 700 comprises an application port 710, a separation zone 720, a transport and detection zone 730, a reflective aspect 740, a transparent aspect 750, and an optical filter 760. In further embodiments, reagents [not shown] may be used also. As shown in FIG. 7, the sample is deposited into the integrated layer 700 via the application port 710. The sample then enters the separation zone 720 wherein the certain components may be filtered and separated from the sample. For example, where the sample is plasma, red blood cells may be separated via use of specific binders within the separation zone that binds/separates other interfering substances. Furthermore, indicators may employed to specifically detect and/or amplify presence of a particular characteristic, such as the existence of an analyte.

The filtered/separated sample then proceeds to the transport and detection zone 730. This zone may be generally more dense, in the case of capillary action, or more hydrophobic, in the case of surface tension, to aid the transport of the separated sample. Non-woven or mesh or other similar material commonly known and used by those skilled in the art may be used to draw the fluid from the separation zone 720 as well. Each of the above methods, either separately or in various combinations with one another, may be used to facilitate transport of the separated sample. In further embodiments, reagents may be used to quench interferents or specify and amplify the desired analyte.

The reflective 740 and the transparent 750 aspects may each be adjacent to the application port 710. These aspects serve similar function to those analogous aspects disclosed in other embodiments of the present invention and previously disclosed hereinabove. The optical filter 760 comprises at least one filter to limit the wavelength entering and exiting the integrated layer 700 and is used in conjunction with the interrogating light source to produce measurement and/or other analysis results. The reflective aspect 740 is opposite of the at least one optical filter 760 as shown in FIG. 7. The optical filter 760 can either be coupled to the integrated layer 700 or separate from it.

The foregoing embodiments and advantages are merely exemplary and are not to be construed as limiting the present invention. The present teaching can be readily applied to other types of devices and applications that may be common to those of ordinary skill in the art. The description of the present invention is intended to be illustrative, and not to limit the scope of the claims. Many alternatives, modifications, and variations will be apparent to those skilled in the art.

What is claimed is:

1. A system for measuring a characteristic of a sample, the system comprising:
a light source;
a light measuring device; and
a sample receptacle, wherein the receptacle receives and emits light from the light source and wherein the emitted light is measured by the light measuring device.

2. The system of claim 1, wherein the receptacle further comprises a reflective surface and a chamber to store the sample.

3. The system of claim 1, wherein the receptacle comprises of an at least one layer.

4. The system of claim 3, wherein the at least one layer comprises of an access layer, a channel layer, and a base layer.

5. The system of claim 4, wherein the access layer comprises an opaque reflective surface.

6. The system of claim 5, wherein the access layer further comprises a first reflective access opening and a second reflective access opening.

7. The system of claim 5, wherein the channel layer comprises a plurality of channel layer openings coupled in communication with one another.

8. The system of claim 7, wherein plurality of openings is in alignment with the second reflective opening.

9. The system of claim 8, wherein the base layer serves as the protective layer of the receptacle such that the sample does not escape the channel layer after receipt from the access layer.

10. The system of claim 3, wherein the at least one layer comprises a plurality of layers coupled to one another.

11. The system of claim 10, wherein the plurality of layers comprise a first layer and a second layer.

12. The system of claim 11, wherein the first layer comprises a reflective section and the second layer comprise a chamber within.

13. The system of claim12, wherein the reflective section and chamber are in alignment and in communication with each other.

14. The system of claim 10, wherein the first layer and the second layer engages with an attachment of the light measuring device.

15. The system of claim 12, wherein the chamber comprises a chamber opening, a first transparent side and a second transparent side.

16. The system of claim 15, wherein the first transparent side is also the cover of the chamber.

17. The system of claim 15, wherein the second transparent side contains the sample while also providing for an aperture through which light from the light source may pass through to illuminate and interrogate the sample.

18. The system of claim 1, wherein the receptacle comprises an integrated layer for filtering and analysis.

19. The system of claim 18, wherein the integrated layer comprises an application port, a separation zone, a transport and detection zone, a reflective aspect, a transparent aspect, and an optical filter.

20. The system of claim 19, wherein the integrated layer further comprises a reagent.

21. A method for measuring a characteristic of a sample comprising the steps of:
(a) illuminating a sample;
(b) collecting the illuminated light from the sample;
(c) measuring a reflected light from the sample; and
(d) determining a characteristic of the sample based on the measurement of the sample's reflective and/or fluorescent properties to know properties,
wherein the sample is contained in a receptacle allowing for the performance of steps (a)-(d).
